(19) United States
(12) Patent Application Publication
(10) Pub. No.: US 2025/0158516 A1
(43) Pub. Date: May 15, 2025

(54) RESONANT CONVERTER AND CONTROL METHOD THEREOF

(71) Applicant: Delta Electronics (Shanghai) Co., Ltd., Shanghai (CN)

(72) Inventors: Bin Wang, Shanghai (CN); Weiyi Zheng, Shanghai (CN); Yuxi Wang, Shanghai (CN); Feidong Xu, Shanghai (CN)

(21) Appl. No.: 18/928,968

(22) Filed: Oct. 28, 2024

(30) Foreign Application Priority Data
Nov. 14, 2023 (CN) 202311515636.5

(51) Int. Cl. H02M 3/00; H02M 3/335

(52) U.S. Cl. CPC H02M 3/01; H02M 3/33573; H02M 3/33576

(57) ABSTRACT

The present disclosure provides a control method applicable for a resonant converter. The control method includes steps of: (a) determining a voltage gain of the resonant converter according to the input voltage, a turn ratio of the transformer and the output voltage, and determining a resonant frequency according to an inductance of the resonant inductor and a capacitance of the resonant capacitor; (b) determining an output current of the resonant converter according to the switching frequency, the voltage gain and the resonant frequency; and (c) adjusting the switching frequency when the output current is not equal to a reference current, and performing the step (b) again.

### CROSS-REFERENCE TO RELATED APPLICATION

This application claims priority to China Patent Application No. 202311515636.5, filed on Nov. 14, 2023, the entire contents of which are incorporated herein by reference for all purposes.

### FIELD OF THE INVENTION

The present disclosure relates to a resonant converter and a control method thereof, and more particularly to a dual-active-bridge (DAB) resonant converter and a control method thereof.

### BACKGROUND OF THE INVENTION

With the development of the smart microgrids, storage systems and electric vehicle systems, high-power DAB circuits are attractive and widely used. Due to the rapid development of the new-type power devices, high-frequency digital processing chips and high-frequency magnetic devices, the advantages of DAB circuits such as electrical isolation, soft switching operation, high power density, high efficiency, bidirectional energy flow and high reliability are further magnified.

The conventional DAB circuits achieve zero-voltage turn-on through adjusting the dead time of bridge arm. However, since the waveform of theoretical resonant tank only contain the fundamental wave component, so the waveform of theoretical resonant tank is different from the actual resonant tank waveform, the existing control method is unable to ensure that zero-voltage turn-on can be achieved under a wide voltage operating range. If the zero-voltage turn-on cannot be achieved, it will cause voltage drop or voltage polarity reversal while turning on the switch, resulting in reducing the efficiency of the converter.

Therefore, there is a need of providing a resonant converter and a control method thereof to obviate the drawbacks encountered from the prior arts.

### SUMMARY OF THE INVENTION

It is an object of the present disclosure to provide a resonant converter and a control method thereof. In the resonant converter and the control method thereof, an output current and a reference current are controlled to be consistent by adjusting a switching frequency of switches in the resonant converter. Therefore, all the switches in the resonant converter can achieve zero-voltage turn-on, and the voltage drop or the voltage polarity reversal caused by non-zero-voltage turn-on of the switches are avoided, thereby improving the efficiency of the converter.

It is an object of the present disclosure to provide a control method of a resonant converter. The resonant converter includes an input terminal, a primary circuit, a resonant tank, a transformer, a secondary circuit and an output terminal. The input terminal provides an input voltage, the primary circuit includes a plurality of switches and is electrically connected to the input terminal. The resonant tank is electrically connected to the primary circuit and includes a resonant inductor and a resonant capacitor electrically connected in series. The transformer includes a primary winding and a secondary winding, the primary winding is electrically connected to the resonant tank, the secondary winding is electrically connected to the secondary circuit. The secondary circuit includes a plurality of switches, the output terminal is electrically connected to the secondary circuit and provides an output voltage, the plurality of switches of the primary circuit and the plurality of switches of the secondary circuit have a switching frequency. The control method includes steps of: (a) determining a voltage gain of the resonant converter according to the input voltage, a turn ratio of the transformer and the output voltage, and determining a resonant frequency according to an inductance of the resonant inductor and a capacitance of the resonant capacitor; (b) determining an output current of the resonant converter according to the switching frequency, the voltage gain and the resonant frequency; and (c) adjusting the switching frequency when the output current is not equal to a reference current, and performing the step (b) again.

It is an object of the present disclosure to provide a resonant converter. The resonant converter includes an input terminal, a primary circuit, a resonant tank, a transformer, a secondary circuit, an output terminal and a controller. The input terminal provides an input voltage. The primary circuit includes a plurality of switches and is electrically connected to the input terminal. The resonant tank is electrically connected to the primary circuit and includes a resonant inductor and a resonant capacitor electrically connected in series. The transformer includes a primary winding and a secondary winding, and the primary winding is electrically connected to the resonant tank. The secondary circuit includes a plurality of switches and is electrically connected to the secondary winding, and the plurality of switches of the primary circuit and the plurality of switches of the secondary circuit have a switching frequency. The output terminal is electrically connected to the secondary circuit and provides an output voltage. The controller determines a voltage gain of the resonant converter according to the input voltage, a turn ratio of the transformer and the output voltage, determines a resonant frequency according to an inductance of the resonant inductor and a capacitance of the resonant capacitor, determines an output current of the resonant converter according to the switching frequency, the voltage gain and the resonant frequency, and adjusts the switching frequency when the output current is not equal to a reference current.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a resonant converter according to an embodiment of the present disclosure;

FIG. 2 schematically shows the waveforms of the switches and currents of the resonant converter of FIG. 1 being in a charging mode with a voltage gain M less than or equal to 1;

FIG. 3 schematically shows the waveforms of the switches and currents of the resonant converter of FIG. 1 being in the charging mode with the voltage gain M greater than 1;

FIG. 4 schematically shows the current flow direction of the resonant converter of FIG. 1 at time t11;

FIG. 5 schematically shows the current flow direction of the resonant converter of FIG. 1 at time t13;

FIG. 6 schematically shows the current flow direction of the resonant converter of FIG. 1 at time t2;

FIG. 7 schematically shows the waveforms of the switches, currents and voltages of the resonant converter of FIG. 1 being in the charging mode with the voltage gain M less than or equal to 1;

FIG. 8 schematically shows the waveforms of the switches, currents and voltages of the resonant converter of FIG. 1 being in the charging mode with the voltage gain M greater than 1;

FIG. 9 schematically shows the waveforms of the switches, currents and voltages of the conventional resonant converter being in the charging mode with the voltage gain M less than or equal to 1;

FIG. 10 schematically shows the waveforms of the switches, currents and voltages of the conventional resonant converter being in the charging mode with the voltage gain M less than or equal to 1;

FIG. 11 schematically shows the waveforms of the switches, currents and voltages of the conventional resonant converter being in the charging mode with the voltage gain M greater than 1;

FIG. 12 schematically shows the waveforms of the switches, currents and voltages of the conventional resonant converter being in the charging mode with the voltage gain M greater than 1; and

FIG. 13 is a schematic flow chart illustrating a control method of the resonant converter according to an embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

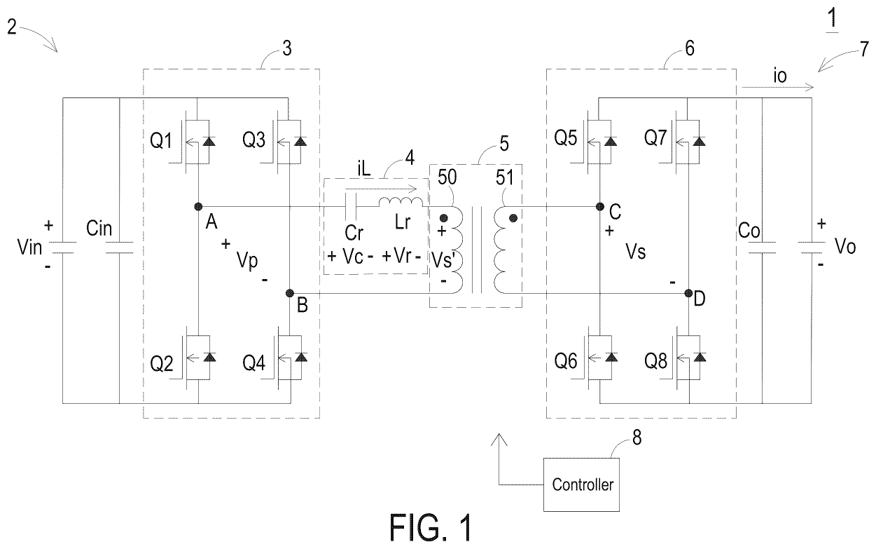

FIG. 1 is a schematic circuit diagram illustrating a resonant converter 1 according to an embodiment of the present disclosure. As shown in FIG. 1, the resonant converter 1 includes an input terminal 2, a primary circuit 3, a resonant tank 4, a transformer 5, a secondary circuit 6, an output terminal 7 and a controller 8. The input terminal 2 provides an input voltage Vin. The primary circuit 3 includes a plurality of switches and is electrically connected to the input terminal 2. The resonant tank 4 is electrically connected to the primary circuit 3 and includes a resonant inductor Lr and a resonant capacitor Cr electrically connected in series. Resonant current iL is the current flowing through the resonant current Cr and the resonant inductor Lr. The transformer 5 includes a primary winding 50 and a secondary winding 51, and the primary winding 50 is electrically connected to the resonant tank 4. The secondary circuit 6 includes a plurality of switches and is electrically connected to the secondary winding 51 of the transformer 5. The plurality of switches of the primary circuit 3 and the plurality of switches of the secondary circuit 6 have a switching frequency fs. The output terminal 7 is electrically connected to the secondary circuit 6 and provides an output voltage Vo.

The controller 8 determines a voltage gain M of the resonant converter 1 according to the input voltage Vin, a turn ratio of the transformer and the output voltage Vo, and determines a resonant frequency fr according to an inductance of the resonant inductor Lr and a capacitance of the resonant capacitor Cr. Moreover, the controller 8 determines an output current io of the resonant converter 1 according to the switching frequency fs, the voltage gain M and the resonant frequency fr, and adjusts the switching frequency fs when the output current io is not equal to a reference current Iref. In an embodiment, when the output current io is greater than the reference current Iref, the controller 8 increases the switching frequency fs. When the output current io is less than the reference current Iref, the controller 8 decreases the switching frequency fs. In an embodiment, the reference current Iref can be set and adjusted according to actual requirements. In an embodiment, the resonant converter 1 further includes an input capacitor Cin and an output capacitor Co, the input capacitor Cin is electrically connected in parallel to the primary circuit 3, and the output capacitor Co is electrically connected in parallel to the secondary circuit 6. In an embodiment, the switching frequency fs is greater than the resonant frequency fr.

In the resonant converter 1 of the present disclosure, the output current io and the reference current Iref are controlled to be consistent by adjusting the switching frequency of the switches in the resonant converter. Therefore, all the switches in the resonant converter 1 can achieve zero-voltage turn-on, and the voltage drop or the voltage polarity reversal caused by the non-zero-voltage turn-on of switches are avoided, thereby improving the efficiency of the converter 1.

The voltage gain M and the resonant frequency fs may be determined according to equations (1) and (2).

$$M = \frac{n {V}_{o}}{{V}_{i n}} \qquad ( 1 )$$

$$fr = \frac{1}{2 π \sqrt{Lr * Cr}} \qquad ( 2 )$$

Wherein n is the turn ratio of transformer, Vo is the output voltage, Vin is the input voltage, Lr is the resonant inductor, and Cr is the resonant capacitor.

The plurality of switches of the primary circuit 3 include a first switch Q1, a second switch Q2, a third switch Q3 and a fourth switch Q4. The first switch Q1 and the third switch Q3 are electrically connected to the positive input terminal Vin+ of the input terminal 2, and the second switch Q2 and the fourth switch Q4 are electrically connected to the negative input terminal Vin− of the input terminal 2. The first switch Q1 and the second switch Q2 are electrically connected in series, and there is a first node A between the first switch Q1 and the second switch Q2. The third switch Q3 and the fourth switch Q4 are electrically connected in series, and there is a second node B between the third switch Q3 and the fourth switch Q4. The resonant tank 4 is electrically connected between the first node A and the first terminal of the primary winding 50, and the second node B is electrically connected to the second terminal of the primary winding 50.

The plurality of switches of the secondary circuit 6 include a fifth switch Q5, a sixth switch Q6, a seventh switch Q7 and an eighth switch Q8. The fifth switch Q5 and the seventh switch Q7 are electrically connected to the positive output terminal Vo+ of the output terminal 7, and the sixth switch Q6 and the eighth switch Q8 are electrically connected to the negative output terminal Vo− of the output terminal 7. The fifth switch Q5 and the sixth switch Q6 are electrically connected in series, and there is a third node C between the fifth switch Q5 and the sixth switch Q6. The seventh switch Q7 and the eighth switch Q8 are electrically connected in series, and there is a fourth node D between the seventh switch Q7 and the eighth switch Q8. The third node C and the fourth node D are electrically connected to two terminals of the secondary winding 51 respectively.

The first switch Q1 and the second switch Q2 are complementary switches, and the third switch Q3 and the fourth switch Q4 are complementary switches. The fifth switch Q5 and the sixth switch Q6 are complementary switches, and the seventh switch Q7 and the eighth switch Q8 are complementary switches. The fourth switch Q4 lags the first switch Q1 by a primary phase shift time φp, the eighth switch Q8 lags the fifth switch Q5 by a secondary phase shift time φs, and the fifth switch Q5 lags the first switch Q1 by a primary-secondary phase shift time φps. The controller 8 determines the primary phase shift time φp, the secondary phase shift time φs and the primary-secondary phase shift time φps according to the switching frequency fs and the voltage gain M.

When the electrical energy flows from the primary circuit 3 to the secondary circuit 6, the resonant converter 1 is in a charging mode, and when the electrical energy flows from the secondary circuit 6 to the primary circuit 3, the resonant converter 1 is in a discharging mode.

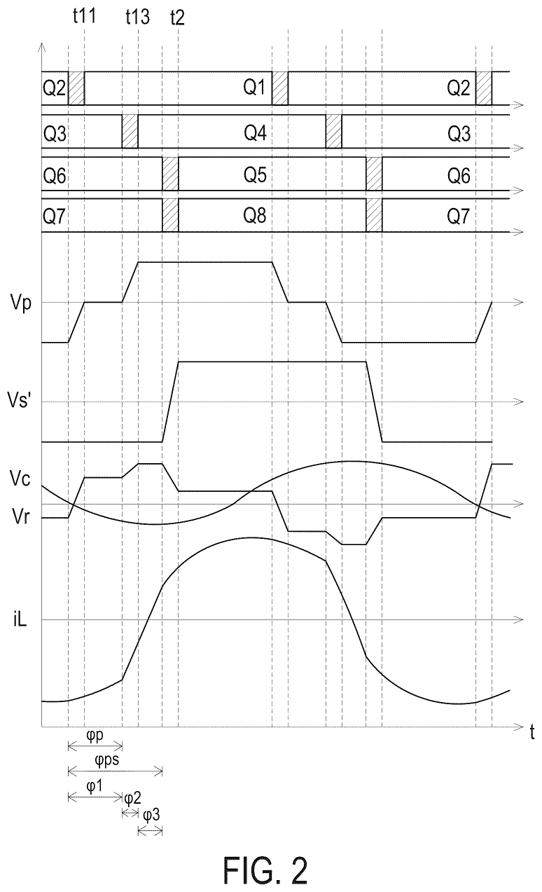

Please refer to FIGS. 1 and 2. FIG. 2 schematically shows the waveforms of the switches and currents of the resonant converter 1 of FIG. 1 being in a charging mode with the voltage gain M less than or equal to 1. As shown in FIG. 2, the primary phase shift time φp is the first time φ1, the secondary phase shift time φs is 0, and the primary-secondary phase shift time φps is the sum of the first time φ1, the second time φ2 and the third time φ3. The primary voltage Vp is the potential difference between the first node A and the second node B, Vs' is the terminal voltage of the primary winding 50, Vc is the terminal voltage of the resonant capacitor Cr, Vr is the terminal voltage of the resonant inductor Lr, and the secondary voltage Vs is the potential difference between the third node C and the fourth node D.

The controller 8 has different primary phase shift time φp, secondary phase shift time φs and primary-secondary phase shift time φps under the charging and discharging modes. In addition, the controller 8 has different primary phase shift time φp, secondary phase shift time φs and primary-secondary phase shift time φps under different voltage gain M. For example, when the resonant converter 1 is in the charging mode with the voltage gain M greater than 1, the primary phase shift time φp is 0, the secondary phase shift time φs equals the first time φ1, and the primary-secondary phase shift time φps is the sum of the second time φ2 and the third time φ3.

When the resonant converter 1 is in the discharging mode with the voltage gain M less than or equal to 1, the primary phase shift time φp is 0, the secondary phase shift time φs is the first time φ1, and the primary-secondary phase shift time φps is the sum of the second time φ2 and the third time φ3.

When the resonant converter 1 is in the discharging mode with the voltage gain M greater than 1, the primary phase shift time φp is the first time φ1, the secondary phase shift time φs is 0, and the primary-secondary phase shift time φps is the sum of the first time φ1, the second time φ2 and the third time φ3.

The specific determination approach of the mentioned first time φ1, second time φ2 and third time φ3 is explained as follows.

When the voltage gain M is less than or equal to 1, the first time φ1 is shown as equation (3).

$$φ1 = max ( arccos ( 2 M - cos ( φ2 + φ3 ) ) - ( φ2 + φ3 ) , 0 ) \qquad ( 3 )$$

When the voltage gain M is greater than 1, the first time φ1 is shown as equation (4).

$$φ1 = max ( arccos ( \frac{2 cos ( φ2 )}{M} - cos ( φ3 ) ) - φ3 , 0 ) \qquad ( 4 )$$

No matter what the voltage gain M is, the second time φ2 is shown as equation (5).

$$φ2 = 2 π Tfs \qquad ( 5 )$$

Wherein T is a fixed time.

No matter what the voltage gain M is, the third time φ3 is shown as equation (6).

$$φ3 = 2 π kTfs \qquad ( 6 )$$

Wherein k is a natural number greater than 0.

The controller 8 determines the output current io according to the primary phase shift time φp, the secondary phase shift time φs, the primary-secondary phase shift time φps and the resonant frequency fr. The determination approach of the output current io is shown in equation (7).

$${i}_{o} = \frac{8 {n}^{2} {V}_{o}^{2}}{{𝔫}^{2} {P}_{o} \sqrt{\frac{L r}{{C}_{r}}} ( \frac{{f}_{s}}{{f}_{r}} - \frac{{f}_{r}}{{f}_{s}} )} cos ( \frac{{φ}_{p}}{2} ) cos ( \frac{{φ}_{s}}{2} ) sin ( {φ}_{p s} ) \qquad ( 7 )$$

Wherein n is the turn ratio of transformer, Pₒ is the output power of the resonant converter 1.

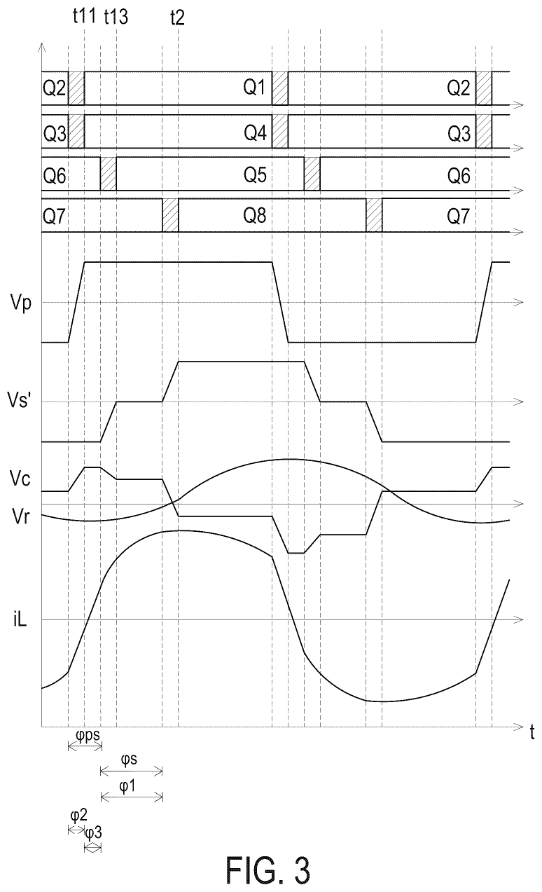

Please refer to FIG. 3. FIG. 3 schematically shows the waveforms of the switches and currents of the resonant converter 1 of FIG. 1 being in the charging mode with the voltage gain M greater than 1. As shown in FIG. 3, the primary phase shift time φp is 0, the secondary phase shift time φs is the first time φ1, and the primary-secondary phase shift time φps is the sum of the second time φ2 and the third time φ3.

The implementation of the resonant converter 1 achieving zero-voltage turn-on of all the switches is exemplified as follow by taking an example when the resonant converter 1 is in the charging mode with the voltage gain M less than or equal to 1.

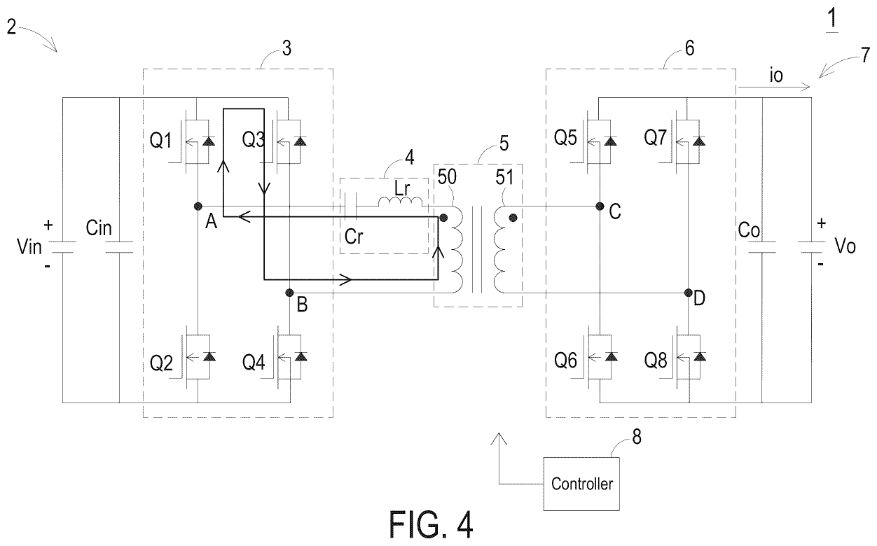

Please refer to FIGS. 2 and 4. FIG. 4 schematically shows the current flow direction of the resonant converter 1 of FIG. 1 at time t11. At time t11, the resonant current iL is negative, the first switch Q1 and the third switch Q3 are turned on, and the second switch Q2 and the fourth switch Q4 are turned off. At this time, the resonant current iL flows through the resonant inductor Lr, the resonant capacitor Cr, the first switch Q1, the third switch Q3 and the primary winding 50 in sequence. Since the first switch Q1 is turned on as an anti-parallel switch, the terminal voltage of the first switch Q1 is approximately 0, and the first switch Q1 achieves zero-voltage turn-on.

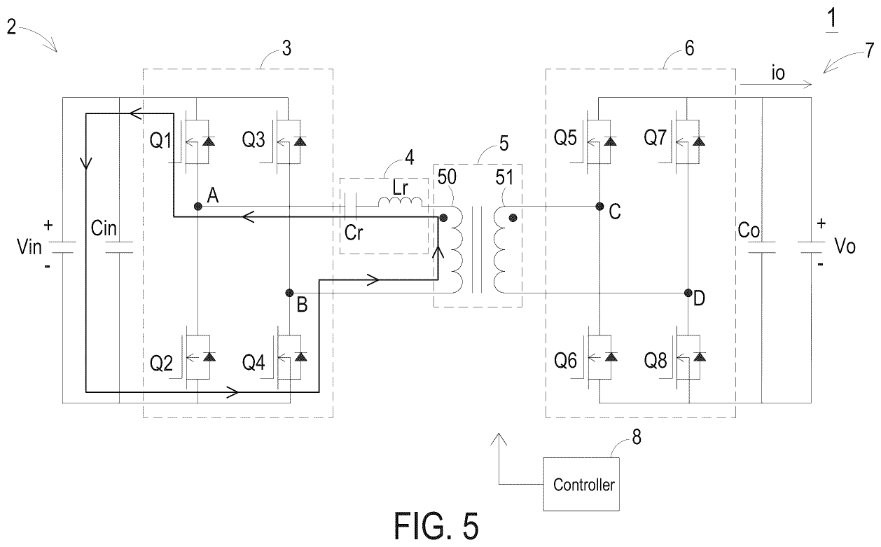

Please refer to FIGS. 2 and 5. FIG. 5 schematically shows the current flow direction of the resonant converter 1 of FIG. 1 at time t13. At time t13, the resonant current iL is negative, the first switch Q1 and the fourth switch Q4 are turned on, and the second switch Q2 and the third switch Q3 are turned off. At this moment, the resonant current iL flows through the resonant inductor Lr, the resonant capacitor Cr, the first switch Q1, the input capacitor Cin, the fourth switch Q4 and the primary winding 50 in sequence. Since the fourth switch Q4 is turned on as an anti-parallel switch, the terminal voltage of the fourth switch Q4 is approximately 0, and the fourth switch Q4 achieves zero-voltage turn-on.

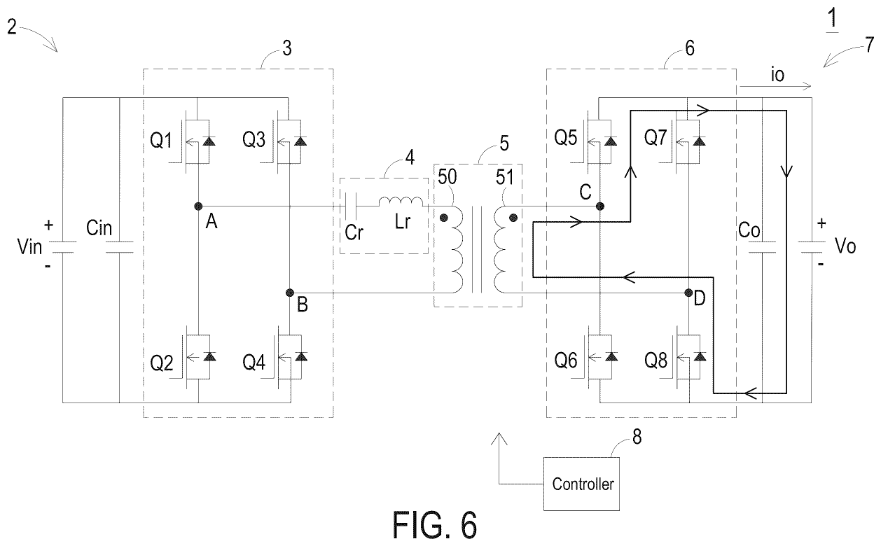

Please refer to FIGS. 2 and 6. FIG. 6 schematically shows the current flow direction of the resonant converter 1 of FIG. 1 at time t2. At time t2, the resonant current iL is positive, the fifth switch Q5 and the eighth switch Q8 are turned on, and the sixth switch Q6 and the seventh switch Q7 are turned off. At this moment, the resonant current iL flows through the secondary winding 51, the fifth switch Q5, the output capacitor Co and the eighth switch Q8 in sequence. Since the fifth switch Q5 and the eighth switch Q8 are turned on as an anti-parallel switch, the terminal voltages of the fifth switch Q5 and the eighth switch Q8 are approximately 0, and the fifth switch Q5 and the eighth switch Q8 achieve zero-voltage turn-on.

In the embodiment that the resonant converter 1 is in the charging mode with the voltage gain M greater than, less than or equal to 1, or in the embodiment of that the resonant converter 1 is in the discharging mode, the zero-voltage turn-on may be achieved by the same way, and thus the detailed descriptions thereof are omitted herein.

The implementation of the resonant converter 1 using the mentioned switching control to achieve zero-voltage turn-on is exemplified as follow according to the schematic waveforms of the switches, currents and voltages of the resonant converter 1. The corresponding waveforms of the conventional switch control method that cannot achieve zero-voltage turn-on are also shown for comparison.

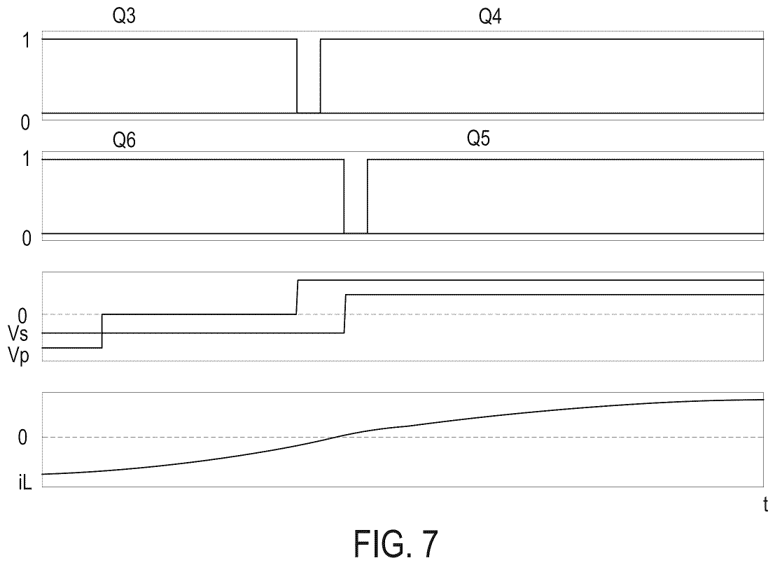

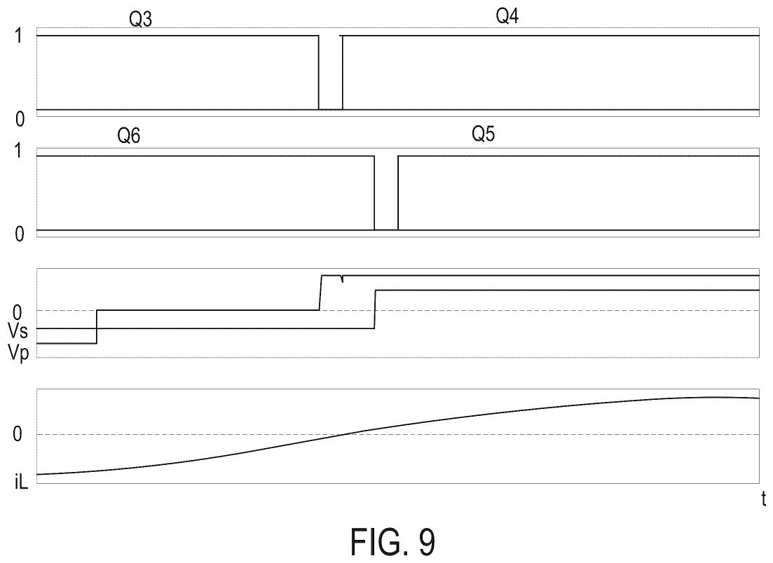

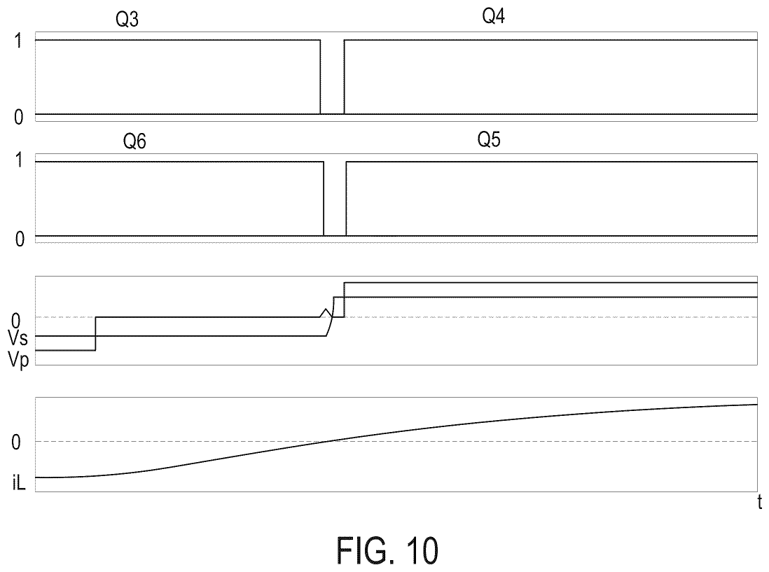

Please refer to FIG. 7, FIG. 7 schematically shows the waveforms of the switches, currents and voltages of the resonant converter 1 of FIG. 1 being in the charging mode with the voltage gain M less than or equal to 1. As shown in FIG. 7, the second switch Q2 and the fourth switch Q4 of the primary circuit 3 achieve zero-voltage turn-on, and the fifth switch Q5 and the eighth switch Q8 of the secondary circuit 6 achieve zero-voltage turn-on. In addition, according to the symmetry characteristics of the switches, the first switch Q1 and the third switch Q3 of the primary circuit 3 achieve zero-voltage turn-on, and the sixth switch Q6 and the seventh switch Q7 of the secondary circuit 6 achieve zero-voltage turn-on. Moreover, there is no voltage drop or voltage polarity reversal in the primary voltage Vp and the secondary voltage Vs, which proves that all the switches of the resonant converter 1 in the present disclosure can achieve zero-voltage turn-on. FIG. 9 and FIG. 10 shows the voltage drop or voltage polarity reversal happening in the conventional resonant converter being in the charging mode with the voltage gain less than or equal to 1.

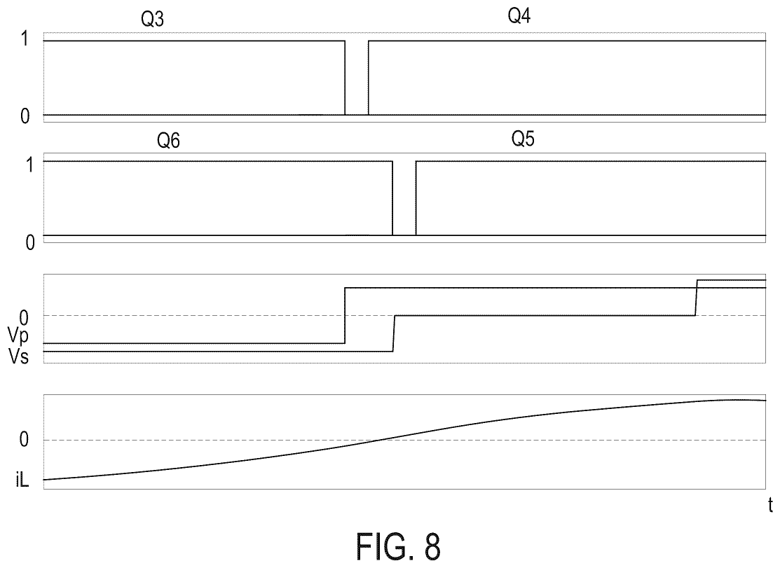

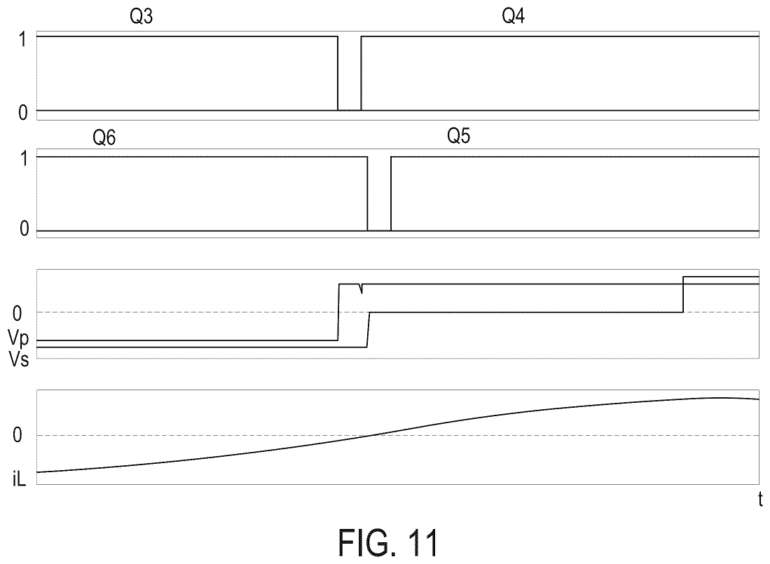

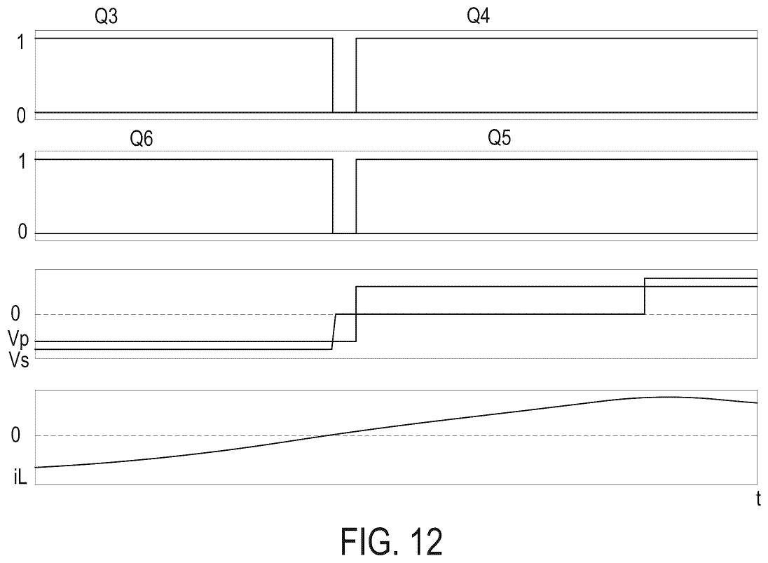

FIG. 8 schematically shows the waveforms of the switches, currents and voltages of the resonant converter 1 of FIG. 1 being in the charging mode with the voltage gain M greater than 1. As shown in FIG. 8, the first switch Q1 and the fourth switch Q4 of the primary circuit 3 achieve zero-voltage turn-on, and the fifth switch Q5 and the eighth switch Q8 of the secondary circuit 6 achieve zero-voltage turn-on. In addition, according to the symmetry characteristics of the switches, the second switch Q2 and the third switch Q3 of the primary circuit 3 achieve zero-voltage turn-on, and the sixth switch Q6 and the seventh switch Q7 of the secondary circuit 6 achieve zero-voltage turn-on. Moreover, there is no voltage drop or voltage polarity reversal in the primary voltage Vp and the secondary voltage Vs, which proves that all the switches of the resonant converter 1 in the present disclosure can achieve zero-voltage turn-on. FIGS. 11 and 12 shows the voltage drop or polarity reversal happening in the conventional resonant converter being in the charging mode with the voltage gain greater than 1.

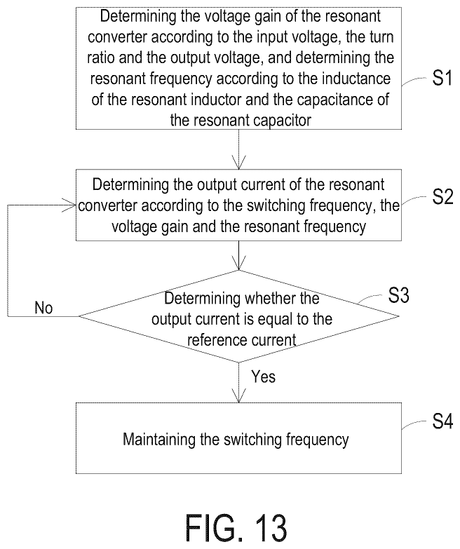

FIG. 13 is a schematic flow chart illustrating a control method of the resonant converter according to an embodiment of the present disclosure. The control method of the present disclosure is applicable for the resonant converter 1 stated above. Please refer to FIG. 13, the control method of the resonant converter 1 of the present disclosure includes steps S1, S2, S3 and S4. In the step S1, the voltage gain M of the resonant converter 1 is determined according to the input voltage Vin, the turn ratio of the transformer and the output voltage Vo, and the resonant frequency fr is determined according to the inductance of the resonant inductor Lr and the capacitance of the resonant capacitor Cr. In the step S2, the output current io of the resonant converter 1 is determined according to the switching frequency fs, the voltage gain M and the resonant frequency fr. In the step S3, whether the output current io is equal to the reference current Iref is determined, the switching frequency fs is adjusted and the step S2 is performed again when the determination result is not satisfied, and the step S4 is performed when the determination result is satisfied. In the step S4, the switching frequency fs is maintained.

In an embodiment, the control method of the resonant converter 1 further includes steps of: determining the primary phase shift time φp, the secondary phase shift time φs and the primary-secondary phase shift time φps according to the switching frequency fs and the voltage gain M; and determining the output current io according to the primary phase shift time φp, the secondary phase shift time φs, the primary-secondary phase shift time φps and the resonant frequency fr.

From the above descriptions, a resonant converter and a control method thereof is provided. In the resonant converter and the control method thereof, the output current and the reference current are controlled to be consistent by adjusting the switching frequency of switches in the resonant converter. Therefore, all the switches in the resonant converter can achieve zero-voltage turn-on, the voltage drop or the voltage polarity reversal caused by non-zero-voltage turn-on of the switch are avoided, thereby improving the efficiency of the converter.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control method of a resonant converter, wherein the resonant converter comprises an input terminal, a primary circuit, a resonant tank, a transformer, a secondary circuit and an output terminal, the input terminal provides an input voltage, the primary circuit comprises a plurality of switches and is electrically connected to the input terminal, the resonant tank is electrically connected to the primary circuit and comprises a resonant inductor and a resonant capacitor electrically connected in series, the transformer comprises a primary winding and a secondary winding, the primary winding is electrically connected to the resonant tank, the secondary winding is electrically connected to the secondary circuit, the secondary circuit comprises a plurality of switches, the output terminal is electrically connected to the secondary circuit and provides an output voltage, the plurality of switches of the primary circuit and the plurality of switches of the secondary circuit have a switching frequency, and the control method comprises steps of:
(a) determining a voltage gain of the resonant converter according to the input voltage, a turn ratio of the transformer and the output voltage, and determining a resonant frequency according to an inductance of the resonant inductor and a capacitance of the resonant capacitor;
(b) determining an output current of the resonant converter according to the switching frequency, the voltage gain and the resonant frequency; and
(c) adjusting the switching frequency when the output current is not equal to a reference current, and performing the step (b) again.

2. The control method according to claim 1, wherein the plurality of switches of the primary circuit comprise a first switch, a second switch, a third switch and a fourth switch, the first switch and the second switch are electrically connected in series, the third switch and the fourth switch are electrically connected in series, the plurality of switches of the secondary circuit comprise a fifth switch, a sixth switch, a seventh switch and an eighth switch, the fifth switch and the sixth switch are electrically connected in series, and the seventh switch and the eighth switch are electrically connected in series.

3. The control method according to claim 2, wherein the fourth switch lags the first switch by a primary phase shift time, the eighth switch lags the fifth switch by a secondary phase shift time, and the fifth switch lags the first switch by a primary-secondary phase shift time.

4. The control method according to claim 3, further comprising steps of:
determining the primary phase shift time, the secondary phase shift time and the primary-secondary phase shift time according to the switching frequency and the voltage gain; and determining the output current according to the primary phase shift time, the secondary phase shift time, the primary-secondary phase shift time and the resonant frequency.

5. The control method according to claim 4, wherein when an electrical energy flows from the primary circuit to the secondary circuit with the voltage gain less than or equal to 1, the primary phase shift time is a first time, the secondary phase shift time is 0, and the primary-secondary phase shift time is a sum of the first time, a second time and a third time, when the electrical energy flows from the primary circuit to the secondary circuit with the voltage gain greater than 1, the primary phase shift time is 0, the secondary phase shift time is the first time, and the primary-secondary phase shift time is a sum of the second time and the third time, when the electrical energy flows from the secondary circuit to the primary circuit with the voltage gain less than or equal to 1, the primary phase shift time is 0, the secondary phase shift time is the first time, and the primary-secondary phase shift time is a sum of the second time and the third time, when the electrical energy flows from the secondary circuit to the primary circuit with the voltage gain greater than 1, the primary phase shift time is the first time, the secondary phase shift time is 0, and the primary-secondary phase shift time is a sum of the first time, the second time and the third time.

6. The control method according to claim 5, wherein when the voltage gain is less than or equal to 1, the first time is shown as:
$$φ1 = max ( arccos ( 2 M - cos ( φ2 + φ3 ) ) - ( φ2 + φ3 ) , 0 )$$
wherein φ1 is the first time, M is the voltage gain, φ2 is the second time and φ3 is the third time,
wherein when the voltage gain is greater than 1, the first time is shown as:
$$φ1 = max ( arccos ( \frac{2 cos ( φ2 )}{M} - cos ( φ3 ) ) - φ3 , 0 )$$
wherein the second time is shown as:
$$φ2 = 2 π Tfs$$
wherein T is a fixed time, fs is the switching frequency,
wherein the third time is shown as:
$$φ3 = 2 π kTfs$$
wherein k is a natural number greater than 0.

7. A resonant converter, comprising:
an input terminal, providing an input voltage;
a primary circuit, comprising a plurality of switches and electrically connecting to the input terminal;
a resonant tank, electrically connecting to the primary circuit and comprising a resonant inductor and a resonant capacitor electrically connected in series;
a transformer, comprising a primary winding and a secondary winding, wherein the primary winding is electrically connected to the resonant tank;
a secondary circuit, comprising a plurality of switches and electrically connecting to the secondary winding, wherein the plurality of switches of the primary circuit and the plurality of switches of the secondary circuit have a switching frequency;
an output terminal, electrically connecting to the secondary circuit and providing an output voltage; and
a controller, determining a voltage gain of the resonant converter according to the input voltage, a turn ratio of the transformer and the output voltage, determining a resonant frequency according to an inductance of the resonant inductor and a capacitance of the resonant capacitor, determining an output current of the resonant converter according to the switching frequency, the voltage gain and the resonant frequency, and adjusting the switching frequency when the output current is not equal to a reference current.

8. The resonant converter according to claim 7, wherein the plurality of switches of the primary circuit comprise a first switch, a second switch, a third switch and a fourth switch, the first switch and the second switch are electrically connected in series, the third switch and the fourth switch are electrically connected in series, the plurality of switches of the secondary circuit comprise a fifth switch, a sixth switch, a seventh switch and an eighth switch, the fifth switch and the sixth switch are electrically connected in series, and the seventh switch and the eighth switch are electrically connected in series.

9. The resonant converter according to claim 8, wherein the fourth switch lags the first switch by a primary phase shift time, the eighth switch lags the fifth switch by a secondary phase shift time, and the fifth switch lags the first switch by a primary-secondary phase shift time.

10. The resonant converter according to claim 9, wherein the controller determines the primary phase shift time, the secondary phase shift time and the primary-secondary phase shift time according to the switching frequency and the voltage gain, and determines the output current according to the primary phase shift time, the secondary phase shift time, the primary-secondary phase shift time and the resonant frequency.

11. The resonant converter according to claim 10, wherein when an electrical energy flows from the primary circuit to the secondary circuit with the voltage gain less than or equal to 1, the primary phase shift time is a first time, the secondary phase shift time is 0, and the primary-secondary phase shift time is a sum of the first time, a second time and a third time, when the electrical energy flows from the primary circuit to the secondary circuit with the voltage gain greater than 1, the primary phase shift time is 0, the secondary phase shift time is the first time, and the primary-secondary phase shift time is a sum of the second time and the third time, when the electrical energy flows from the secondary circuit to the primary circuit with the voltage gain less than or equal to 1, the primary phase shift time is 0, the secondary phase shift time is the first time, and the primary-secondary phase shift time is a sum of the second time and the third time, when the electrical energy flows from the secondary circuit to the primary circuit with the voltage gain greater than 1, the primary phase shift time is the first time, the secondary phase shift time is 0, and the primary-secondary phase shift time is a sum of the first time, the second time and the third time.

12. The resonant converter according to claim 11, wherein when the voltage gain is less than or equal to 1, the first time is shown as:
$$φ1 = max ( arccos ( 2 M - cos ( φ2 + φ3 ) ) - ( φ2 + φ3 ) , 0 )$$
wherein φ1 is the first time, M is the voltage gain, φ2 is the second time and φ3 is the third time,
wherein when the voltage gain is greater than 1, the first time is shown as:
$$φ1 = max ( arccos ( \frac{2 cos ( φ2 )}{M} - cos ( φ3 ) ) - φ3 , 0 )$$
wherein the second time is shown as:
$$φ2 = 2 π Tfs$$
wherein T is a fixed time, fs is the switching frequency,
wherein the third time is shown as:
$$φ3 = 2 π kTfs$$
wherein k is a natural number greater than 0.
